(19) United States
(12) Patent Application Publication
(10) Pub. No.: US 2007/0027736 A1
(43) Pub. Date: Feb. 1, 2007

(54) Planning tool

(76) Inventors: Damon Reynolds, London (GB); Liz Soutar, London (GB); Simon James, Wiltshire (GB); Nicholas Rich, Bristol (GB); Kate Rosser, London (GB); Alejandra Oliver, London (GB); Dominic Keen, London (GB); Nicholas Leonard, Cheshire (GB); Dan Hurell, London (GB); John Fussell, London (GB); Adam French, London (GB); Paul Oram, Surrey (GB); Steve Osborn, Berkshire (GB); Andrew MacLaren, London (GB)

Correspondence Address: Pristine Johannessen;Brown Raysman Millstein Felder & Steiner, 900 Third Avenue, New York, NY, 10022, US

(21) Appl. No.: 10/558,968

(22) PCT Filed: Jun. 1, 2004
(86) PCT No.: PCT/GB04/02297

§ 371 Date: Nov. 30, 2005

(30) Foreign Application Priority Data
Jun. 2, 2003 (GB) 0312649.7
Jan. 14, 2004 (GB) 0400777.9

(51) Int. Cl. G06F 9/46

(52) U.S. Cl. 705/8; 705/35; 708/112

(57) ABSTRACT

There is disclosed a computer apparatus incorporating a model component for calculating time series and a user interface component for controlling the model and displaying the time series. The user interface allows events to be defined which are used by the model, by positioning event markers relative to an event schedule graphic. The apparatus may be used as a financial planning tool, in which case the model is a financial model and the events are financial events. Such a planning tool may further incorporate a component to provide planning suggestions based on the model and defined events.

### INTRODUCTION

Computer-based tools for assisting a user in making predictions based on a number of assumptions, to thereby assist in a planning process, are widely known, for example in the field of economics. Such tools are also known in the fields of medicine and engineering. While many such tools are common place in professional or academic use, in recent years, a number of such tools have also been developed as software packages for domestic or consumer use. These tools generally require a user friendly interface which is capable of gathering all the required information from a user, a mathematical model for carrying out a time integration and a simple graphical output of the results of the time integration.

WO 01/65907 provides a financial planning tool to assist a user in managing their personal finances. The tool allows the user to input personal and financial information such as age, salary, interest rates and risk-aversion, as well as information relating to particular financial goals, such as achieving a particular retirement income at a certain age or buying a home of a certain value. The tool then allows the user to examine trade-off scenarios between the financial goals. A graphical user interface presents to the user a number of images, each image representing a financial goal. For example, an image of a car may be used to represent the goal of buying a car. Slider controls are used to adjust preference parameters relating to each goal. Such preferences may include “quality” of the related product, “time” to obtain the goal, and “priority” indicating importance of the goal. As the preferences of goals are adjusted using the slider controls, an underlying mathematic model continually recalculates outcome parameters for each goal, which depend on trade-offs between the various user-set preferences. A “quality” outcome for a goal is represented graphically by changes to the subject matter of the related image, for example an image could change from that of a large house to that of a small house. As a “time” outcome for a goal becomes greater the corresponding image becomes more faded.

The “Microsoft Money 2003” software product incorporates a “Lifetime Planner Tool” which provides more comprehensive facilities to assist a user in making long term financial plans. Relevant personal and financial details are input, such as: details of children and their planned educational costs; income including earings and anticipated events such as promotions and job changes, inheritances, retirement benefits; tax and inflation parameters; planned and existing savings, investments and life insurance policies; expected returns on investments; house price changes and purchase expectations; regular expenses, existing debts and one-off costs or similar financial events. The tool then plots a time series of total assets for a number of years into the future, as a bar chart, based on a forward integration of a financial model constrained by the input user data.

To investigate different scenarios, a user of “Microsoft Money” can reenter particular financial information, add goals or events, and then instruct the package to recalculate and replot the bar chart, along with the results of the previous calculation, if required for comparison.

### SUMMARY OF THE INVENTION

The present invention seeks to address the problems and disadvantages of the related prior art. In particular, it would be desirable to provide a planning tool which enabled a user of a planning tool to more quickly and easily investigate the results of changes to parameters and events used as input to an underlying model.

It would also be desirable to provide such a planning tool having a graphical control representing time, wherein the graphical control is compact and simple to operate. It would also be desirable to provide improved facilities for controlling the display of the graphical control, and for a user to easily experiment with changes to parameters and events by interaction with the graphical control.

It would also be desirable to provide a planning tool and associated methods for personal finance and other applications, having an improved arrangement of functional areas to provide facilities for both planning events or targets and determining actions or options to assist in meeting those events or targets.

It would also be desirable to provide computer systems and methods having improved architectures for meeting these needs in the prior art.

Accordingly, the invention provides a computer apparatus comprising:

a model component adapted to calculate time series of one or more indicator variables dependent on a plurality of model parameters, at least some of said model parameters being event parameters relating to one or more events, each event having at least one associated event time parameter; and

a user interface component adapted to cause at least a part of the scope of said time series to be graphically represented as an event schedule graphic and to enable a user to position one or more event markers relative to said event schedule graphic, said user interface component being further adapted to cause one or more of said event time parameters to be set dependent on the position of each event marker relative to the event schedule graphic.

Such an apparatus can be used to assist a user in investigating the interaction between one or more possible time-based events and outcomes of a model which takes account of those events.

Conveniently, the time series may be graphically displayed beneath, alongside, or in another convenient relationship to the event schedule graphic, or timeline. Advantageously, the time axes of the displays of the indicator variables and the event schedule graphic may be substantially parallel and substantially in-line.

Advantageously, the event schedule graphic may be functionally one dimensional, in the sense that positioning of the event markers on or relative to the graphic provides control of only one variable, especially a time variable, rather than attempting to use the graphic in a two dimensional control mode, where positioning of the event markers could, for example, also control a monetary amount. Such a second, dimension, and other parameters relating to an event can be much more conveniently controlled using other means such as pop-up dialogue boxes or speech bubbles related graphically to the event markers, while at the same time realising a more compact event schedule graphic so as to free up graphical user interface space for other uses.

To make the event schedule graphic easier to user, this graphic may represent a controllable portion of the whole scope of the time series, the portion being controllable by means of a timeline navigation element. Such an element may, for example be provided by a miniature display representing substantially the whole time series, with draggable controls to change the portion displayed as the event schedule graphic.

The user interface may also be adapted to enable a user to exclude one or more existing events, so that events which have been defined can be easily included or excluded in the model calculations. An excluded event could be represented by a faded-out marker or flag.

Preferably, the apparatus provides an interactive display so that the indicator variables are recalculated and redisplayed as parameters are changed using the user interface component.

The computer apparatus is preferably implemented in software running on one or more computer workstations or servers. Conveniently, the model component may be held on a server. The user interface component may include user interface software executing on a browser remote from said server where the model component is being executed. Alternatively, the components of the computer apparatus could be co-located.

In a preferred embodiment the computer apparatus provides a financial planning apparatus, in which the model component implements a financial model and the events are financial events. If the financial planning apparatus is for consumer use then the financial events could include events such as “planning for retirement”, “buying a house” and so on.

The invention also provides a graphical user interface, for example provided as part of or driven by the above mentioned user interface component, the graphical user interface comprising:

one or more indicator variable graphics displaying time series of one or more indicator variables calculated using a model on the basis of a plurality of model parameters, at least some of said model parameters being event parameters relating to one or more events, each event having at least one associated event time parameter;

an event schedule graphic representing at least a part of said time series; and

an event marker facility adapted to enable a user to place one or more event markers in locations relative to said schedule graphic, and to cause to be generated event parameters for an event corresponding to each event marker, an event time parameter for each event so generated being set according to the location of the marker relative to the schedule graphic. The invention includes any such graphical user interface itself, software causing such an interface to execute on a computer, and a computer executing the graphical user interface. The invention also provides a method of providing a user with a graphical interface having corresponding steps, and the interface and method having features discussed above in respect of the planning apparatus. The invention also provides a financial planning tool comprising:

a user profile entry module adapted to receive a plurality of financial parameters from a user;

a lifeplan module adapted to receive a plurality of event parameters relating to a plurality of financial events from a user, said event parameters including at least one event time parameter for each event; and

a financial model module adapted to calculate time series of one or more indicator variables from said financial parameters and said event parameters.

Preferably, the financial planning tool further comprises a lifeplan user interface adapted to enable a user to generate one or more events and to place said events at selected points within the said time series, said lifeplan user interface further displaying graphically said time series of said indicator variables.

The invention also provides a method of automatically calculating a plurality of financial suggestion options from a plurality of financial parameters describing the financial position of a user and a plurality of event parameters describing financial goals of said user, comprising:

following a predefined sequence of suggestion steps, each step relating to a predefined suggestion area; for each suggestion step determining from said financial parameters and said event parameters whether or not to calculate suggestion options for that step; and

for each suggestion step for which suggestion options are to be calculated, calculating suggestion options for that step.

Preferably, for each step for which suggestion options are calculated, the method also includes receiving a selection of said suggestion options from said user and building a financial plan for each such step based on the selected suggestion options, each financial plan including one or more plan parameters.

The suggestion steps may comprise two or more suggestion steps taken from the following sequence: paying off one or more types of debt, addressing income deficits, building a rainy day fund and saving for one or more future events.

The invention also provides computer program products, whether written on a computer readable medium, in a signal transmitted over a network or in another electronic form, or installed on part of a computer system, arranged to put into effect any of the above aspects of the invention.

### BRIEF DESCRIPTION OF THE DRAWINGS

Embodiments of the invention will now be described, by way of example only and with reference to the accompanying drawings, of which:

FIG. 1 illustrates a graphical user interface and associated computer apparatus according to a first embodiment of the invention;

FIG. 2 illustrates some of the possible variations to the user interface of FIG. 1;

FIG. 3 illustrates a series of stages of a financial planning process put into effect by a second embodiment of the invention;

FIG. 4 illustrates an alternative series of stages of a financial planning process or elements of a corresponding apparatus;

FIG. 5 shows a computer system for putting the planning process of FIG. 3 or 4 into effect;

FIG. 6 shows another computer system for putting the planning process of FIG. 3 or 4 into effect;

FIG. 7 illustrates, in more detail, the user interface component of FIG. 6;

FIG. 8 illustrates, in more detail, the main application component of FIG. 6;

FIG. 9 illustrates, in more detail, the database component of FIG. 6;

FIG. 10 illustrates a structure of the financial model implemented by the financial model component of FIG. 8;

FIG. 11 illustrates the structure of a suggestion model implemented by the suggestion engine component of FIG. 8;

FIG. 12 illustrates the lifeplan graphical user interface effected by the corresponding interface component of FIG. 7;

FIG. 13 illustrates an event prioritization interface effected by the suggestion centre interface component of FIG. 7;

FIG. 14 shows the lifeplan interface of FIG. 9 with additional plan graphics; and

FIG. 15 shows a table of some suitable financial events.

### DESCRIPTION OF EMBODIMENTS

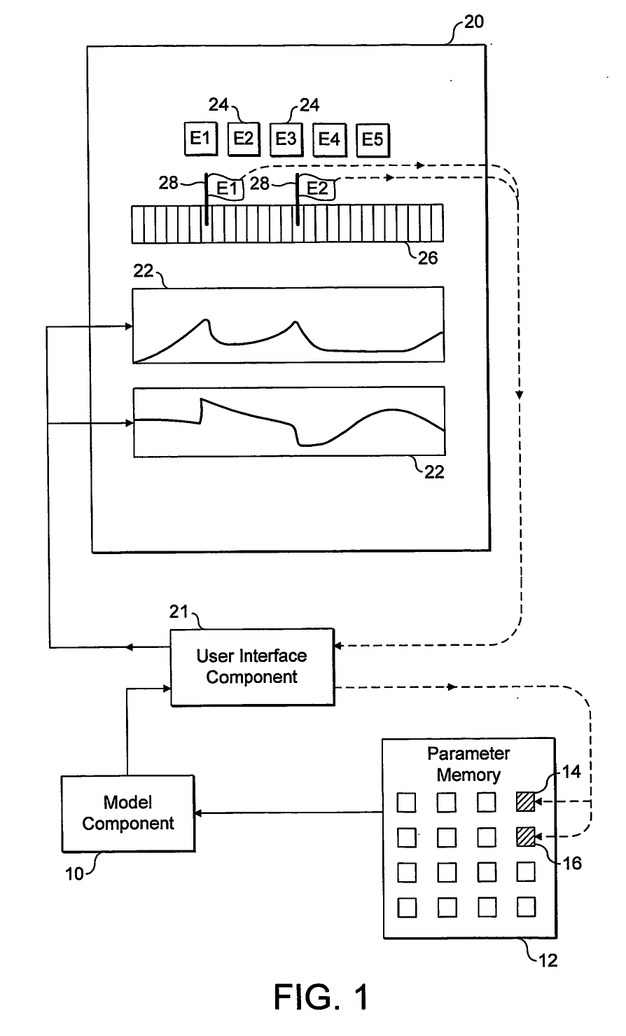

Referring first to FIG. 1 there is shown a graphical user interface 20 (GUI) provided by a user interface component 21 and associated computer apparatus according to a first embodiment of the invention. A model component 10 is arranged to calculate one or more time series, including time series of one or more key “indicator variables”, on the basis of a number of model parameters held in a parameter memory 12. The calculated time series of the indicator variables are passed to the user interface component 21 for display within the GUI as indicator variable graphics 22.

Typically, many of the model parameters will be preset, or will be input using another GUI component invoked prior to the use of the illustrated GUI 20. However, the GUI 20 provides the user with facilities for setting up extra event parameters 14, 16 relating to “events”. An event is generated, for example, by selecting a graphical event selector 24 and then selecting a position within the modelled time series at which to place the generated new event. Different event selectors 24 are provided for generating events of different types or classes of types E1, E2, E3 and E4 which may, for example, require different event parameter sets for inclusion in the parameter memory 12, for constraining the model component 10.

The GUI may be used to generate an event by selecting an event type or class by directing a cursor within the GUI 20 to one of the event selectors 24, selecting the selector, then moving the cursor and releasing or deselecting at a location indicative of the chosen position within the time series. This type of dynamic may conveniently be implemented as a mouse controlled “drag and drop” action. To assist the user in accurate use of the dropping or deselection action, an event schedule graphic 26 (or timeline) is provided, which preferably has a time axis parallel to the time axes of the indicator variable graphics 22, and more preferably has a time axis parallel to, aligned with and of the same scale as those of the indicator variable graphics 22. The event selectors 24 may be provided by graphical buttons, menus or any other means.

The above discussed “drag and drop” type action to place a selected event on or relative to the event schedule graphic 26 causes the user interface component 21 to generate an event marker 28 which is displayed at a location within or proximate to the event schedule graphic 26, the location indicating the position in the time series of the associated event. The event marker 28 may be graphically rendered in the GUI 20 as a flag or similar graphic, preferably indicating graphically the type or class of event marked.

The actions required to generate and place a new event marker 28 trigger the generation or setting of appropriate event parameters 14, 16 need to include the event in the next execution of the model component 10. These event parameters include at least one event time parameter which represents the time position marked by the event marker 28. The user interface may also provide facilities for subsequent modification of event parameters. For example, a dialogue box could be launched on selection of an event marker 28 using the pointer device. Initial values of each event parameter 14, 16 could also be set up using a similar dialogue box launched on selection of a graphical new event selector. Event markers 28 may be moved, for example, using the pointer device in a drag and drop action, with the associated event time parameter being updated accordingly.

Preferably, the model component 10 recalculates the time series, and the indicator variable graphics 22 are updated automatically when one or more of the parameters held in the parameter memory 12 are changed, and especially when an event is modified or a new event is generated. The event schedule graphic could be incorporated within one or more of the indicator variable graphics, or could be provided by one or more of these graphics.

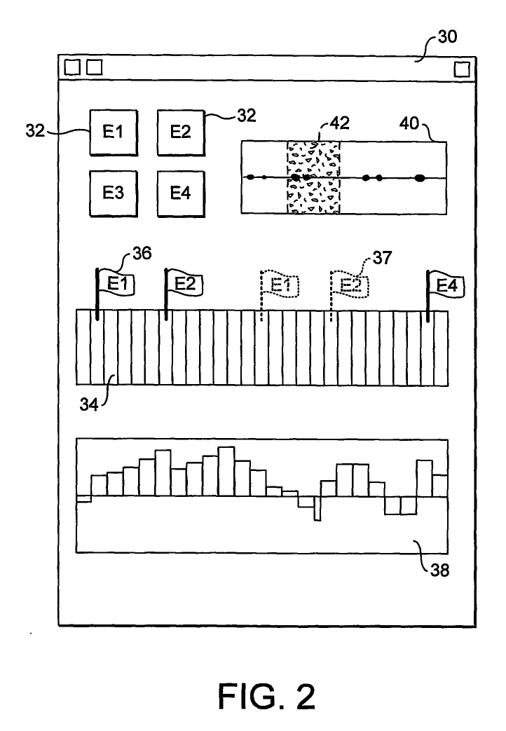

Referring now to FIG. 2, there is shown a GUI similar to that illustrated in FIG. 1, but incorporating a number of variations, each of which may be incorporated into the arrangement of FIG. 1. The GUI 30 of FIG. 2 includes event selectors 32, an event schedule graphic 34 (or timeline) onto which event markers 36 may be placed, and one or more indicator variable graphics 38, these elements being linked to a user interface component, a model component and a parameter memory as illustrated in FIG. 1. Additionally, FIG. 2 shows a timeline navigation element 40 comprising a representation of all or a larger part of the modelled time period, the timeline navigation element having a current display window 42. The event schedule graphic 34 and the one or more indicator variable graphics 38 represent an adjustable current portion of the modelled time period, and the scope of the portion is represented by the current display window 42. The current portion of the modelled time period is preferably adjustable, by user interaction with the timeline navigation element, for example by dragging or stretching the element using a pointing device. Indicator variable graphics preferably adjust automatically to display the same scope as the event schedule graphic.

To help a user accurately align an event flag with the desired drop point on the event schedule graphic, the user interface displays a vertical shadow down from a flag during a drag and drop action, the shadow intersecting with the current locating position on the event schedule graphic.

A user can elect to exclude an existing event from the current model calculations. When an event is excluded, the corresponding flag icon changes appearance, for example being lightened or discoloured, as shown by event flags 37 in FIG. 2. Exclusion may be achieved by locating a cursor over a flag and pausing (“hovering”), causing the user interface to display a speech bubble type graphic providing access to an exclude button. A similar mechanism may be used to include a previously excluded event.

A user can also move, or remove flags from the event schedule graphic 34. To move a flag, a select and drag function can be used, or an editable time field may be displayed, through the speech bubble type mechanism mentioned above. To remove a flag, a user can select the flag and then select a remove-event control elsewhere on the interface, drag an event flag to a remove-event control, or select a remove control via the above mentioned speech-bubble type functionality.

The event schedule graphics 26, 34 shown in FIGS. 1 and 2 preferably provide only one logical control dimension, in the sense that the location of an event flag relative to the event schedule graphic defines only one parameter, typically a time parameter for the flag event. By avoiding two, or possibly more control dimensions, the user interface is more straightforward to use and less confusing. Also, less space is taken up by an event schedule graphic with only one control dimension, leaving more room in the GUI for other functionality.

The arrangements illustrated in FIGS. 1 and 2 are typically implemented using conventional computer apparatus, including a visual display unit, pointer device such as a mouse to control a screen cursor, data memory and a central processing unit. The GUI 20, user interface component 21, model component 10 and parameter memory 12, and software supporting these components, may be implemented using software and hardware at a single computer workstation, or distributed across two or more computers linked by appropriate data communication or network means.

Conveniently, the GUI can be deployed using a largely stateless browser client communicating with a server over an electronic network, with the server processing all underlying data and providing logical functionality, and the browser client performing graphical rendering and user input functions.

The arrangement of FIG. 1 and/or FIG. 2 may be used to assist control and visualization of a model and its results for a variety of purposes where convenient generation and modification of events tied to a modelled time series is advantageous. Such purposes include modelling the response of a clinical patient to drug doses, and modelling a manufacturing process. Another particular application is in personal financial planning. The more detailed embodiment set out below is in this last field, and also includes a number of other aspects of the invention not illustrated in the arrangements of FIGS. 1 and 2.

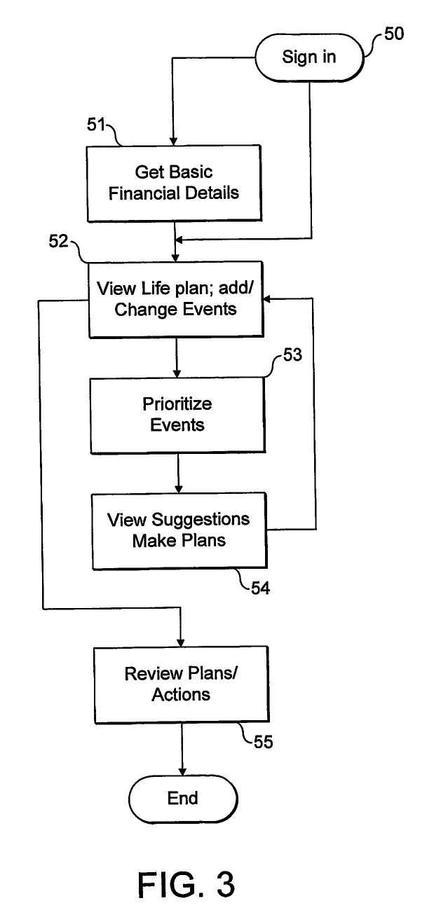

Referring now to FIG. 3 there is shown a sequence of stages through which a user may be guided by a second embodiment of the invention. The sequence of stages assist the user in making finance-related plans through means of a financial model and suggestion or proposals engine. The second embodiment takes the form of a suitably programmed computer system, the software running on elements of that system, and also associated methods and user interfaces, which will together be referred to as the “planning tool”. The corresponding elements illustrated in FIGS. 1 and 2 as discussed above may be used within embodiments of and variations on this planning tool.

After a sign-in process 50 to provide suitable authentication, a user of the planning tool is asked by the tool to provide a variety of personal and financial details, at step 51. These details may include name, address, age, marital status, ages of dependents, as well as more specific financial details including income and expenditure streams such as salary and regular bills, bank accounts, bank balances, investments and anticipated liabilities.

The details requested in step 51, rendered, for example, into a parameter set and stored in a parameter memory 12 as illustrated in FIG. 1, should be sufficient, along with appropriate default values, to constrain a financial model to predict the users modelled financial state for some years into the future. Background economic parameters such as inflation, interest and investment return rates, and taxation may be neglected, provided with default values or supplied by the user.

Having obtained basic financial details in step 51, the planning tool uses the financial model (provided, for example, by model component 10 of FIG. 1) to establish a financial lifeplan in step 52. Using a graphical user interface such as that illustrated in FIG. 1, the user is enabled to create, move and change financial events which are added into the financial model, and the predicted financial state for the user is redisplayed accordingly, for example using one or more indicator variable graphics as illustrated in FIG. 1. Financial events may be one-off events such as buying a car or getting married or may be longer term commitments such as paying school fees or buying a house and subsequently repaying a mortgage. The new event selectors 24 of FIG. 1 illustrate one way in which financial events may be created.

As an alternative to the input step 51 illustrated in FIG. 3, some or all of the user's personal and financial details may be input during the lifeplan step 52 as and when required, thus avoiding the need for step 51, partly or altogether.

When the user has set up a lifeplan to their satisfaction the planning tool asks them to put priorities on the selected events in step 53, for example by a simple ordering of importance. Aversion to financial risk may also be indicated. The planning tool then generates financial suggestions in step 54, typically as a number of options selectable by the user. By selecting one or more options and returning to the lifeplan step 52, with the selected options now included with the parameters driving the financial model, the user can review the results of the chosen options, and their impact on future financial status.

During further iterations of these steps a user can fine tune their plans in respect of planned financial events and suggestion options. Finally, the planning tool takes the user through a review step 55 in which important and suggested action points are listed. The review step may provide facilities for setting up future reminders to be sent to the user, for example by email or SMS.

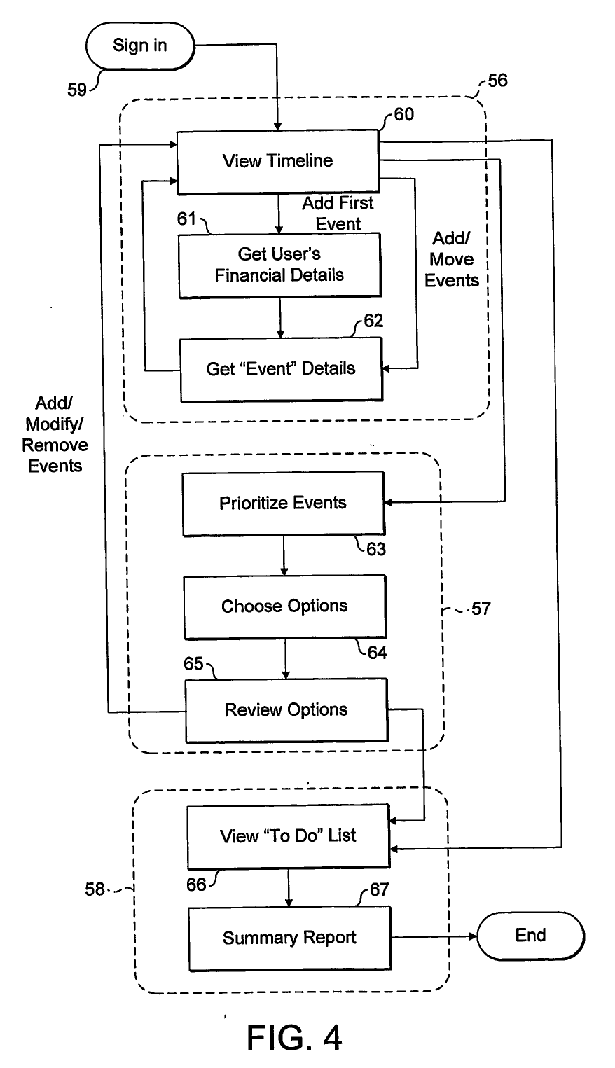

FIG. 4 illustrates a number of alternatives and variations to the series of stages shown in FIG. 3. Each area, step or stage illustrated in FIG. 4 and the functionality thereof may be implemented by a corresponding element of a planning tool implemented on one or more computers. The guided planning process is divided into three areas: a timeline area 56, an options area 57 and a to-do list area 58. The user must interact with each of these functional areas to reach a point at which the planning tool can output a set of personal finance strategies, relevant instructions to the user, and a printed summary report.

Firstly, the timeline area 56, which may be implemented as discussed above in connection with FIGS. 1 and 2, is used to gather data from the user, for example to provide financial model parameters. This data includes personal financial details such as salary and savings, and details pertinent to planned financial events. The timeline area 56 of FIG. 4 corresponds broadly to the “view lifeplan; add/change events” step 52 and the “get basic financial details” step 51 of FIG. 3, in combination. After a “sign in” step 59, a “view timeline” step 60 provides access to an interface such as that illustrated in FIGS. 1 and 2. When the user adds a first event the interface requests financial details in step 61 before obtaining details of the requested event in step 62 and returning to the “view timeline” step. Existing events can then be moved and changed and new events added without passing through the step 61 of requesting financial details.

From the “view timeline” step 60 access is provided to the options area 57, where the user is asked to prioritize the events in step 63, so as to allow a planning or suggestions mechanism to generate a discrete set of financial planning suggestions, solutions, or options. The user may choose any of the options, in step 64, to employ as part of a personal finance strategy to achieve a particular event. Each event has a series of associated possible options, the viability of which are assessed on the basis of a decision tree. Chosen options are presented to the user in a review options step 65, from which the user may return to the view timeline step 60 of the timeline area 56, or proceed to the “view to-do list” step 66 of the to-do list area 58.

Consequent from the user's choice of options, the planning tool calculates a set of to-do list items, relating to the activities that the user will need to carry out over a coming time period, such as six-months, in order to put into effect the financial strategies represented by the chosen options. The to-do list items are presented to the user in step 66, and a summary report is available in step 67. The user may wish to use a home printing device to print the summary report, which is generated by the planning mechanism as a result of the user's prioritization and options selection activities.

The user can elect to add events and choose options in an iterative fashion based on the feedback received from the view timeline indicator graphics. Alternatively, all relevant data can be used in generating and reviewing options.

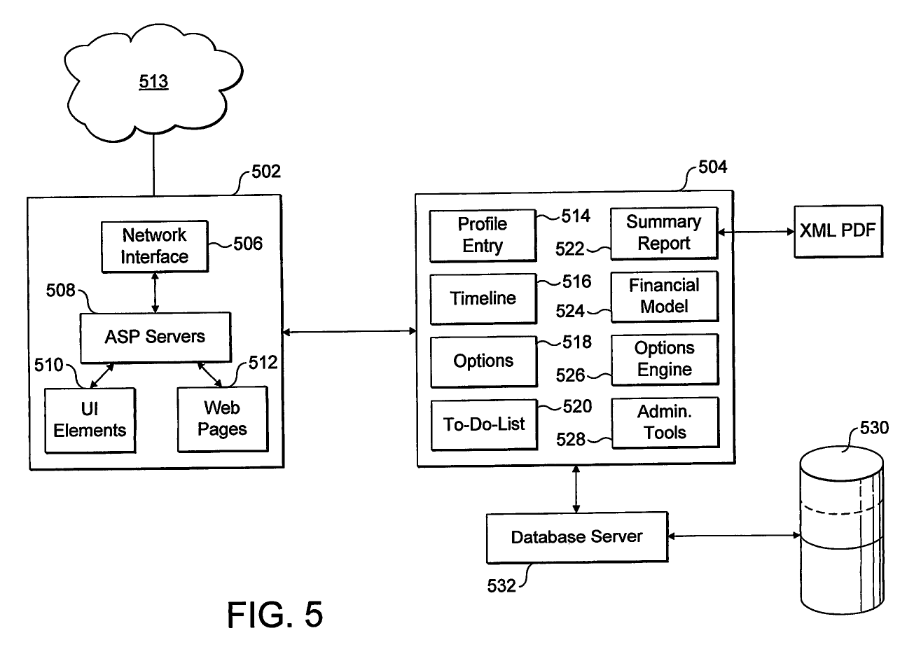

FIG. 5 shows, schematically, components of an arrangement of the planning tool outlined above with reference to FIGS. 3 and 4. A distributed configuration of functional computing elements is used for the calculation of personal finance strategies and associated instructions.

The elements are mostly distributed between a user interface component 502 and a main application component 504, which communicate with each other.

The interface component includes a network interface 506 in communication with one or more Active Server Page Servers 508, which are, in turn, in communication with user interface elements 510 and HTML pages 512. User interface component 502 communicates with client or user elements over network 513 using the network interface 506. Client communications are managed by the ASP servers 508 using the user interface elements 510 and html pages 512.

The main application component 504 contains a number of user interface modules which use the corresponding user interface components 510 to present data and receive instructions from users or clients.

The user interface modules include: a profile entry module 514 and a timeline module 516 which together implement the functionalities of timeline area 56 of FIG. 4; an options module 518 which implements the options area 57 of FIG. 4; and a to-do list module 520 which implements the functionality of the to-do list area 58 of FIG. 4.

The main application component 504 also includes a number of other modules, including: a summary report module 522 which implements the summary report step 67 of FIG. 4; a financial model 524 to calculate the future state of a user's finances based on the available model parameters; an options engine 524 to generate a discrete set of planning solutions, or options, for the user to choose and review in steps 64 and 65 of FIG. 4; and administration tools 528.

The modules of the main application component 504 communicate with a database 530 using a database server 532. The database contains user (or customer) profiles, including financial parameters, events generated using the timeline module 516, options generated and selected using the options module 518 and plans made using the to-do list module 520. The database also contains more user non specific data such as templates, options parameters and general financial model parameters.

Thus it can be seen that four primary modules drive the functionality of the user interface presented to users over the network 513: profile entry, timeline, options and to-do list. The user interface is generally presented at a user browser, which is largely stateless with respect to the planning tool, and which uses a flash component to present the user interface components 510.

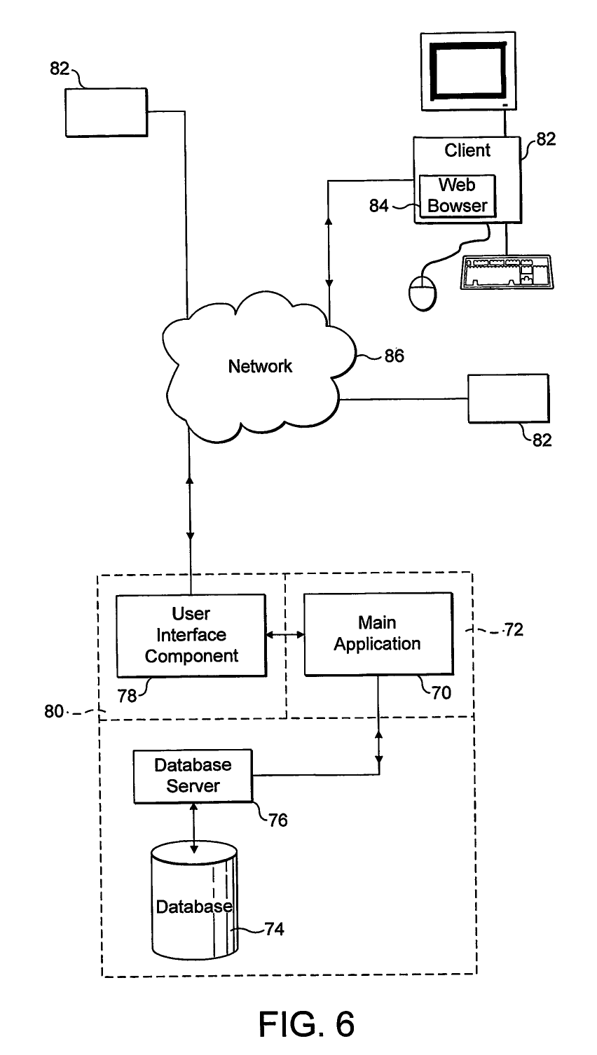

A more specific and detailed embodiment of a planning tool as outlined in the discussion of FIGS. 3 to 5 is illustrated in FIGS. 6 to 13. Although such a planning tool could easily be implemented on a single computer workstation, the arrangement shown in FIG. 6 is implemented as a client-server arrangement, as is that of FIG. 5. A main application 70, written in an object oriented programming language such as C++, or a variant thereof such as C#, runs on an application server 72. Data for access by the main application 70 is held in a database 74 and is accessed using a database server 76. The main application 70 interacts with one or more users via a user interface component 78 running on a web server 80. Each server component may run on a common computer, or the servers may be implemented on separate, or be distributed across a plurality of computer entities.

A user accesses the planning tool using a client computer 82, which will typically be a personal computer having conventional peripherals such as a mouse, keyboard and screen. A web browser application 84 running on a client computer 82 puts the user interfaces provided by the web server 80 into effect and enables the user to communicate with the main application 70 through a network 86, such as the publically accessible Internet, to which the client and web server computers are both connected.

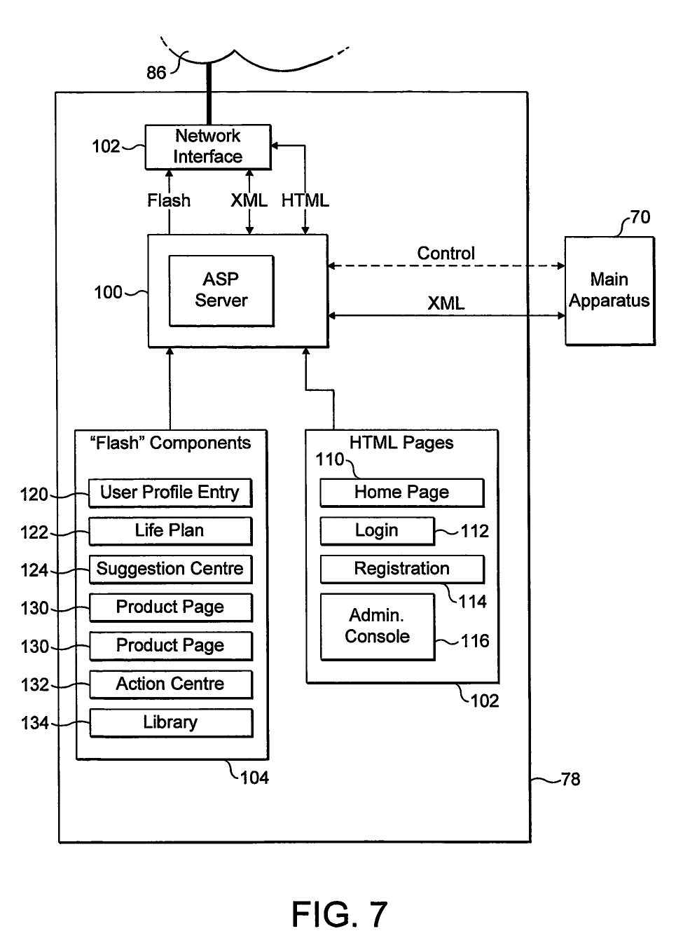

Further details of the user interface component are illustrated in FIG. 7. A number of different user interface modules are held in one or more areas of memory 102, 104. Each user interface module provides data and instructions for the particular user interface to be implemented by a web browser 84 implemented on a client 82 as shown in FIG. 6. The areas of memory 102, 104 could be provided by local non-volatile storage, the database 74 of FIG. 6, or any other means, and are illustrated as stored within the user interface component 78 for convenience only.

Memory area 102 contains a number of HTML (Hypertext Markup Language) pages. These are used where relatively simple interaction with a user is required. A homepage 100 provides an initial introduction to a new or registered user when a new connection is first established between a client 82 and the user interface component 78, and contains hypertext links to a login page 112 and a registration page 114, should these be required to control access to the planning tool. An administration console 116, for use by an administrator in configuring and controlling the planning tool may also be provided.

Memory area 104 contains a number of Flash® movie components. For details of the Flash tool, see the Macromedia website at www.macromedia.com. When executed on a Flash engine operating as part of a web browser 84 a Flash movie provides much more complex user interaction and graphical facilities than can be obtained, at least without great difficulty, than when using the HTML pages held in memory area 102.

The Flash movie components shown in FIG. 7 include a user profile entry movie 120, a lifeplan movie 122, a suggestion centre movie 124, a number of product page movies 130, an action centre movie 132 and a library movie 134.

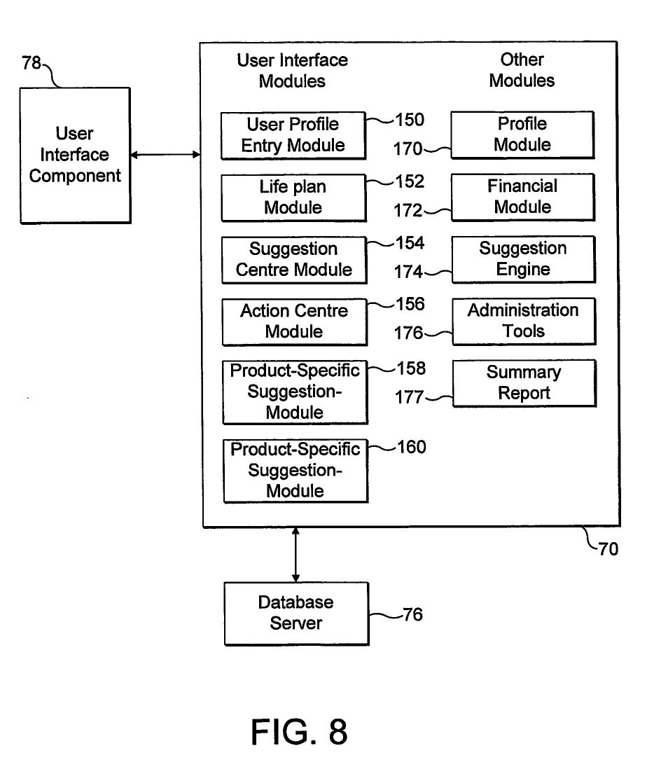

The user profile entry movie 120, when executed by a client web browser 84, provides a user with facilities for entering a variety of personal and financial details. This is carried out in conjunction with a user profile entry module 150 forming a part of the main application 70, discussed below. Many of these details correspond to parameters required by the financial model 250 and suggestion engine 350 illustrated in FIG. 8 and discussed below. Some details may be purely for administrative or marketing purposes, such as name, home address, email, and details of organisations currently providing financial services to the user.

The user profile entry movie 120 may be implemented as a questionnaire divided into numerous popup dialogue boxes, or more preferably using a tabbed-dialogue approach dividing a complete questionnaire into financial areas such as “Earnings and Retirement”, “Family and Lifestyle”, “Home and Mortgage” and “Savings and Loans”. As an example, the “Earnings and Retirement” dialogue might require entry of the user's current total annual income before tax, current pension fund size, anticipated retirement age and income and so on. Preferably, the dialogue is structured so that a user need only complete a limited part of the dialogue, such as just a first “Earnings and Retirement” section before proceeding to use the lifeplan movie 122. The later completion of other parts of the dialogue will subsequently increase the amount of data available to the financial model 250 and suggestion engine 350, thus improving the quality of the suggestions provided by the planning tool.

Sensible default values are provided for necessary parameters when a user has not supplied a value. Validation of entered data is used to check for consistent and sensible parameter values. Such validation may check, for example, that a salary is within a normal range, that retirement age is less than an upper threshold, and that outgoings are reasonably consistent with income. A user can return to the user profile entry movie 120 from other parts of the planning tool, in order to amend the entered parameters. Facilities are also provided to enable a user to move easily from the user profile entry movie 120 to other interface modules such as the lifeplan movie 122.

As already discussed in connection with FIG. 5, some or all of the function of the user profile entry movie 120 and corresponding module 150 may be incorporated into the lifeplan movie 122 and module 152, with user data being requested at suitable times during execution of the lifeplan movie, for example in response to new events being requested.

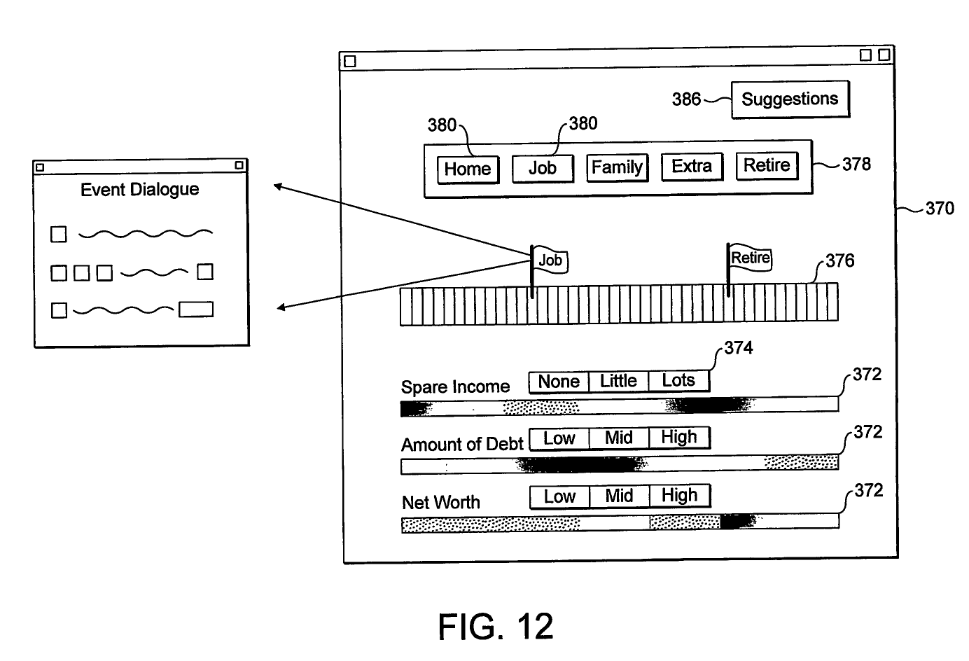

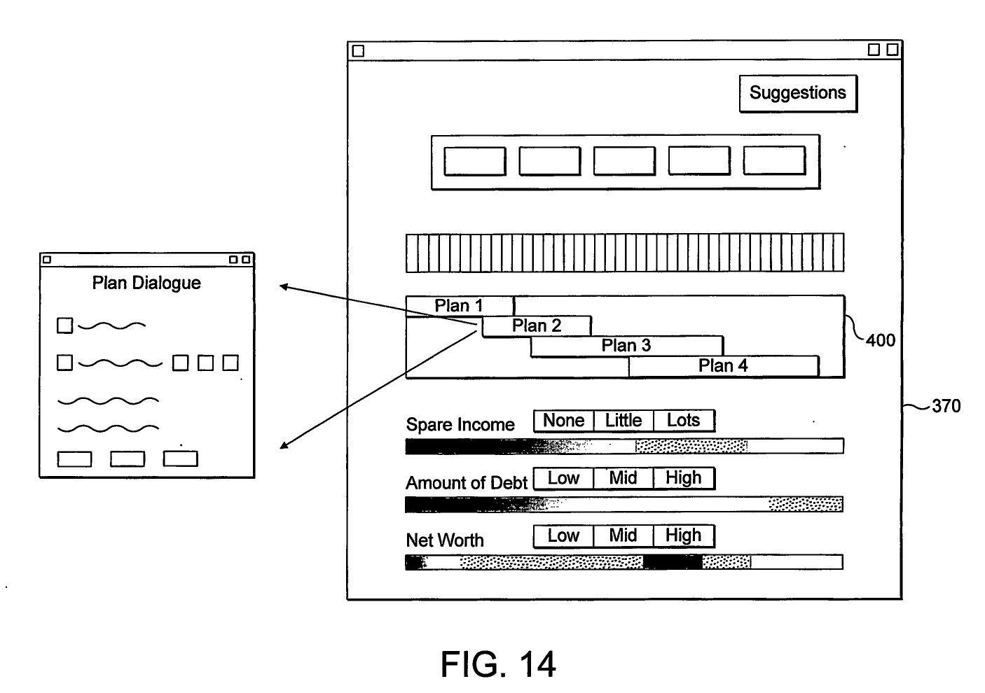

The lifeplan movie 122 implements, when executed on a client browser 84, a graphical user interface similar to the GUIs 20, 30 illustrated in FIGS. 1 and 2, and puts into effect the view lifeplan stage of FIG. 3 or the timeline area of FIG. 4. This is carried out in conjunction with a lifeplan module 152 forming a part of the main application 70, discussed below. The lifeplan movie 122 and its interaction with the rest of the planning tool will be described in detail later in connection with FIGS. 12 and 14, so only a basic discussion is given here. The lifeplan movie uses the financial model 250 to derive time series of one or more indicator variables, and displays these time series graphically. The indicator variables may include some or all of “Spare income”, “Amount of Debt”, “Net worth”, “Retirement”, and the indicator variable graphics may be, for example, conventional line graphics, bar charts, traffic light style L.E.D. charts, or colour block lines with colours indicating different categories such as “lots”, “little” and “negative”; “none”, “medium”, “high”; and “yes”, “nearly”, “no”.

Conveniently, the indicator variable graphics may be selectable, for example using a pointer device (eg “clickable”), to launch a display of the calculations or numbers used to define part or all of the graphic.

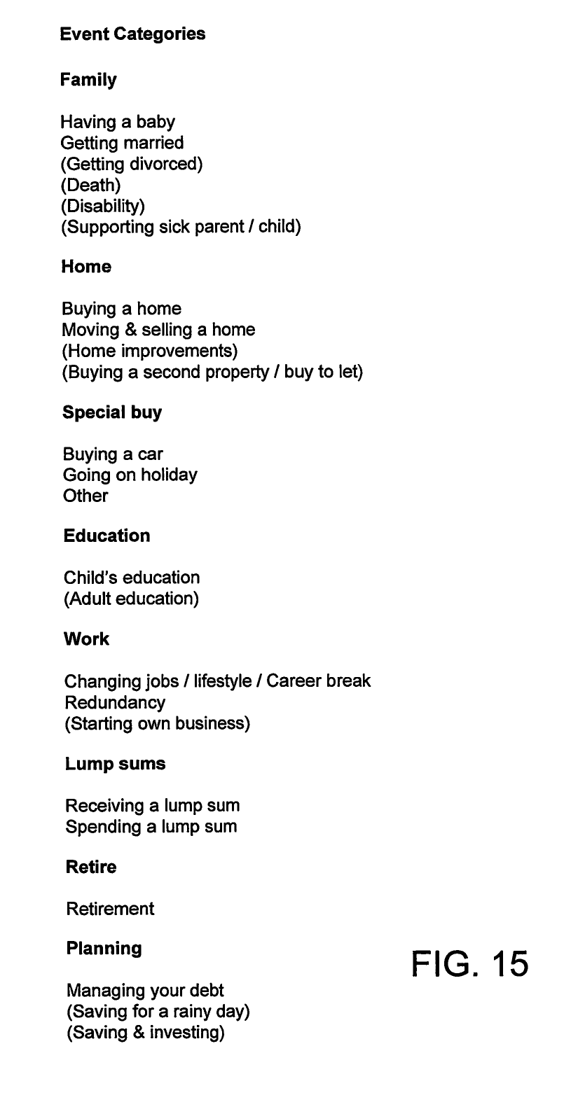

A pallette of icons, a menu or other convenient structure corresponding functionally to the new event selectors of FIGS. 1 and 2 enables a user to create a new event. A new event may be “Buying a first house”, “Buying a second house”, “Moving house”, “Educating a child”, “Special purpose”, “Windfall”, “Salary change”, “Receive a bonus” or any other instantaneous or ongoing event with financial implications. A table of some suitable event types, grouped into categories, is given in FIG. 15. The lifeplan movie 122 enables a user to input required parameters relating to each new event, and to indicate a time of occurrence. These parameters are added to those used to constrain the financial model 250. When a user changes parameters of the financial model 250 from within the lifeplan movie 122, the financial model 250 is preferably re-executed and the indicator variable graphics refreshed accordingly, so as to reflect the changes made. The lifeplan may be operated with a time resolution of 1 year, 1 month or any other suitable interval. A facility is also provided to enable a user to move on to the suggestion centre movie 124 when he has set up the model parameters to his satisfaction.

The suggestion centre movie 124, when executed on a client browser 84, seeks to provide the user with financial suggestions based on the financial parameters entered using the user profile entry movie 120 and the parameters of events entered using the lifeplan movie 122. The suggestion centre movie 124 operates in conjunction with a suggestion centre module 154 to implement the options area 57 of FIG. 4, and forms a part of the main application discussed below. Financial suggestions, or options, are generated and supplied to the suggestion centre module 154 by a suggestion engine 350 (equivalent to the options engine of FIG. 5).

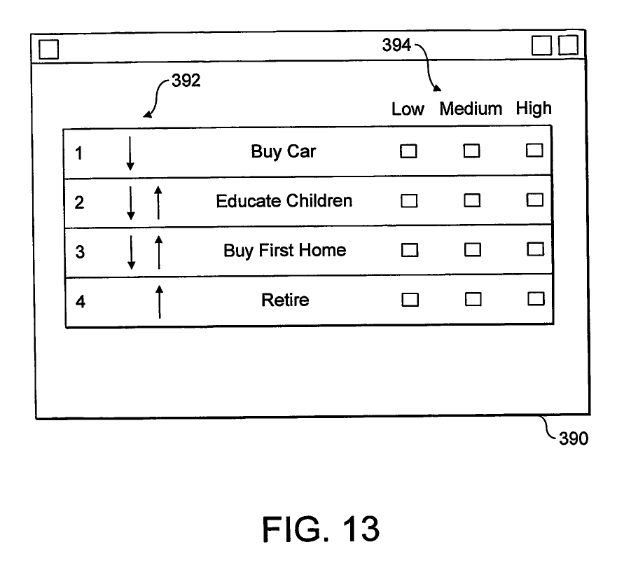

Before suggestions are provided, the user is asked to prioritize the events which were generated using the lifeplan movie 122. This may be achieved using a dialogue box such as that illustrated in FIG. 13, which asks a user to place the events in a chosen order. The user may also be asked to select a level of caution or risk which they wish to associate with each or all events. The information gathered during this stage is used by the suggestion engine 350 to determine in what order to tackle the users “goals” as represented by the events, and what growth expectations can be used for savings or investments allocated towards achieving these goals.

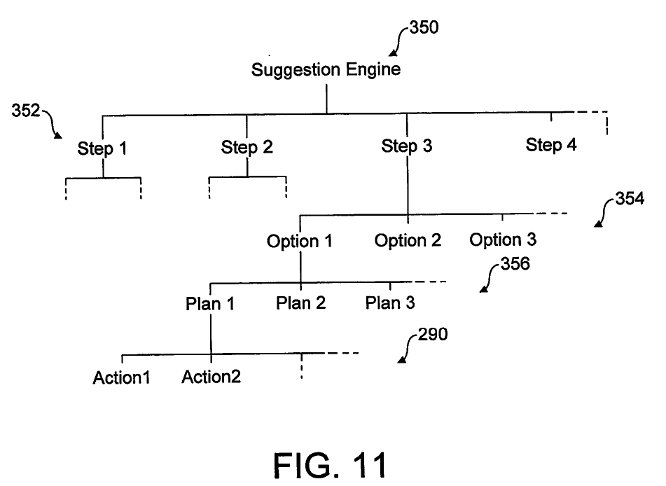

Using the financial parameters now available and the priority and risk for each event, a series of suggestion stages are presented by the suggestion centre movie 124. A dialogue is associated with each suggestion stage. The dialogues present the suggestions generated by the suggestion engine 350, which is discussed in detail below with reference to FIG. 11. Typically, the suggestion stages follow an order which would conventionally be used by a financial adviser, for example beginning with system generated suggestions such as “Getting out of debt”, “Maintaining a rainy day fund”, and then proceeding with the event goals as prioritized by the user. An option may be provided to also enable a user to prioritize the system generated suggestions.

For each suggestion stage there may be several ways in which a user could arrive at the goal or event. The suggestion centre movie 124 presents the user with these alternative options and makes recommendations based on industrial best practice and suitability for the user. Option buttons with the dialogue for each stage enable a user to read a text-based explanation.

Suggestion Options chosen by the user are used to generate financial plans comprising financial suggestion parameters used when the lifeplan movie 122 is re-entered to model the impact of the chosen options on the time series of indicator variables. Chosen options may include actions of changing existing model parameters, such as time parameters of particular events. An example of such an action would be to delay a retirement event. Such parameter changing actions, and other impacts of chosen options are also reflected when the lifeplan movie 122 is re-entered. Chosen suggestion options may be directly illustrated in the graphical user interface generated by the Lifeplan movie 122, for example as time-bars, as illustrated in FIG. 14, discussed below. As an alternative, suggestion options may be indicated on event flags, for example using a small “s” in the corner of the flag for each event having one or more generated suggestion options. To see the options or plans a user selects the associated event flag using a mouse or other pointing device.

Product page movies 130 provide details and selectable options relating to particular financial products or classes of products, and may be accessed from within the suggestion centre movie 124 if required. Alternatively, tables and hypertext links to guide a user to relevant information may be provided, for example using the action centre movie 132.

The action centre movie 132, in conjunction with the main application, provides the function of the “to-do-list” in FIG. 5, or the “to-do-list” area in FIG. 4, or the “review plans/actions” stage in FIG. 3. The action centre movie provides the user with an opportunity to review the planning process by providing a list of actions that the user should implement to improve their financial circumstances and/or achieve the goals they have set out by means of defining events. Instructions may be presented to a user on an event-by-event basis or at an aggregated level, for example in terms of event-related or total required savings. The movie provides facilities enabling the user to set up reminders against action items with any frequency or start date. Reminders may take the form of emails or SMS messages sent to the user.

The library movie 134 provides the user with a variety of background materials such as discussions relating to types of financial product, taxation and pension regulations.

A variety of other, or different movies to those discussed above could, of course, be provided, and the discussed elements could be provided using HTML pages, Java scripts, or using a variety of other tools apart from or in addition to Flash movies.

A dialogue manager 100 forwards the Flash movies and HTML pages contained in memories 102 and 104 to a web browser 84 at a client 82 via a network interface 101, and manages the subsequent interaction between the movies and pages executed on the browser and associated modules of the main application 70. This interaction may be carried out using XML (Extendable Markup Language) or a variant thereof such as SOAP (Simple Object Access Protocol), which is a lightweight XML-based object language. The dialogue manager 100 may typically be provided by an active server page (ASP) server executing on web server 80.

Details of the main application 70 are illustrated in FIG. 8. The main application is preferably implemented using an object-oriented language such as C++ or a variant thereof, and is illustrated in FIG. 8 as comprising a plurality of modules, including user interface modules and other modules. The user interface modules include a user profile entry module 150, a lifeplan module 152, a suggestion centre module 154, an action centre module 156 and any product specific suggestion modules 158, 160. Each of these user interface modules communicates, via the dialogue manager 100 of FIG. 7, with a corresponding one of the Flash movies when executing on a client 82, and provides for appropriate use of and data flow to and from the other main application modules.

The other main application modules shown in FIG. 8 are a profile module 170, a financial model module 172, a suggestion engine module 174, an administration tools module 176 and a summary report module 177. The administration tools module provides services to the administration console 116 of FIG. 7, and may be implemented in a separate execution space or on a different computer from other parts of the main application, and in particular behind a firewall to make illegitimate access from the network 86 more difficult. The summary report module 177 passes XML to a third party application called XML PDF, and implements the summary report step 67 of FIG. 4.

The profile module 170 provides a uniform central point of access for other modules to read and write data from and to the database 74, and in particular personal and financial details entered by a user, other model parameters such as those relating to specified financial events and details of suggestions provided and financial suggestion options chosen.

The financial model module 172 extracts parameters from the database 74 using the profile module 170 and constructs a corresponding financial model 250 on demand. This model has, as outputs, time series of the indicator variables for display by the lifeplan movie 122, as well as other outputs required by the suggestion centre module 154 and suggestion engine module 174.

The suggestion engine module 174 uses the profile module 170 to extract all relevant data from the database 74 and constructs a series of suggestion options which are passed by the suggestion centre module 154 to an instance of the suggestion centre movie executing at a client 82 for selection by a user. Suggestion options selected by a user, and extra required parameters entered by a user, are passed to the profile module 170 for storage in the database 74 as one or more action plans.

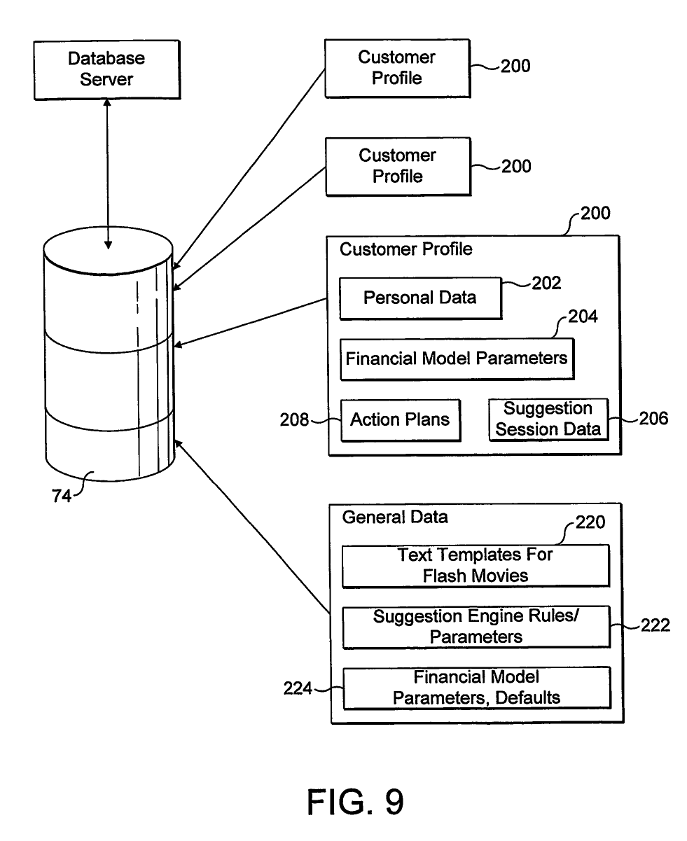

Some of the data elements stored in the database 74 which are relevant to this description of the planning tool are illustrated in FIG. 9. In one embodiment the database server is a SQL server and the database 74 is a relational database.

For each different user of the planning tool the database stores a customer profile 200. A customer profile 200 comprises personal data 202 relating to the user, such as name, postal address, email address. It also contains financial model parameters 204, including age, salary, number of dependents, bank account details, current bank account balances and investments and so on. These parameters will typically have been input through use of the user profile entry movie 120. The financial model parameters 204 also include parameters defining events which have been set up by a user using the lifeplan movie 122.

Each customer profile 200 may also include one or more blocks of suggestion session data 206 containing parameters describing the outcome of a user working through an instance of the suggestion centre movie 124 one or more times, and written to the database 74 by the suggestion centre module. Each customer profile 200 may also include one or more blocks of Action Plan data corresponding to output from an instance of the action centre movie 132 including reminders and text descriptions.

Apart from customer profile data 200, the database may also store a variety of other data elements including text templates 220 for any of the Flash movies stored in the memory area 104 of the user interface component 78, rules and parameters 222 for driving the suggestion engine implemented by the suggestion engine module 174, and non-customer specific parameters and default parameters 224 for the financial model implemented by the financial model module 172, including taxation rules, default inflation and investment return rates, and default or conventional retirement annuity yields.

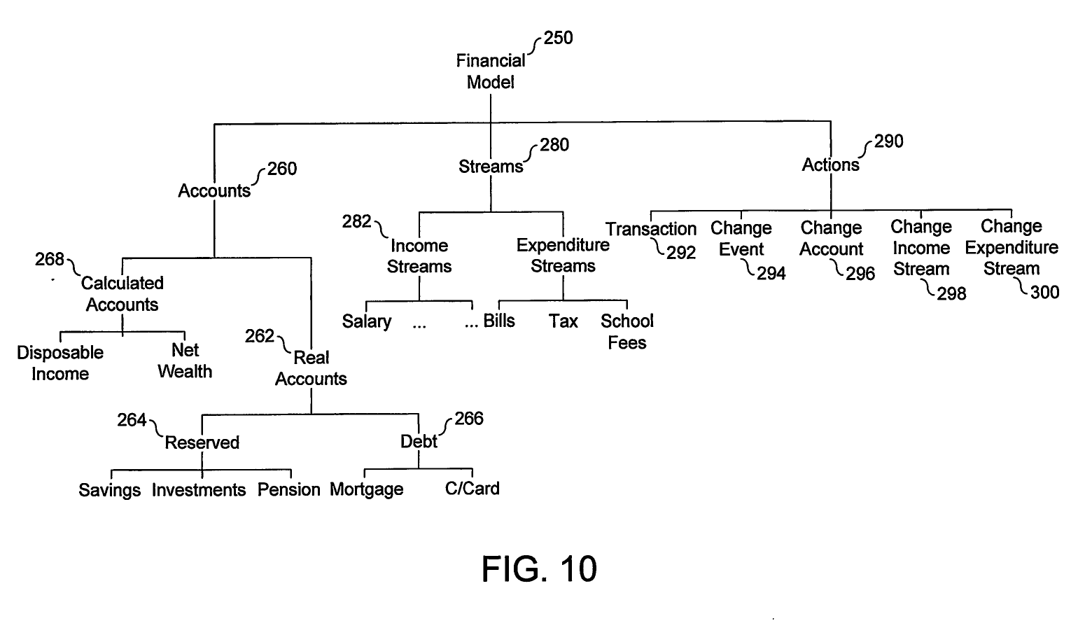

A way in which a financial model 250 may be implemented by the financial model module 172 using an object-oriented construction is shown in FIG. 10. FIG. 10 shows a hierarchy of inherited object types, each of which types may be instantiated into one or more objects of that type, each object containing relevant data and being linked to or containing methods, implemented by suitable computer program instructions, for handling that data, and for carrying out the model calculation that generates time series of the indicator variables.

The financial model 250 includes financial accounts 260, financial streams 280 and financial actions 290. Accounts store wealth or debt, and streams move wealth or debt into, out of and between accounts. Parameters defining a users accounts and transactions are stored in a customer profile 200 as financial model parameters. There are at least two types of account, including real accounts 262 and calculated accounts 268. Real accounts 262, in turn, include reserved accounts 264 and debt accounts 266. The methods associated with reserved accounts allow some of the money in an account to be denoted as reserved for a particular goal, which may be linked to an event defined by the user, and hence not available for other purposes. Reserved accounts may include a user's current bank account, savings accounts and pension funds. A debt account 266 generally holds negative wealth, such as a mortgage or credit card account.

Calculated accounts 268 are derived from other accounts. The indicator variables displayed as time series by the lifeplan movie 122 are totals from calculated accounts 268. Typical calculated accounts are “total savings”, “total investments” and “spare cash”.

A single set of financial model parameters stored in a customer profile 200 may include definitions of multiple similar accounts of the same type, such as loans, which are each represented by an account object of the appropriate type. A calculated account may also be created to represent the aggregated accounts, such as total loans.

Without any streams 280 or other actions 290, accounts 260 change only according to any interest rate applied to each account. The income growth is recorded explicitly so that it can be identified for tax purposes. Accounts, however, can be affected by streams 280, which cause wealth to move into and out of accounts.

Each account is responsible for handling the propagation of streams 280 or actions 290 moving money into or out of that account. The effect of an action or stream can propagate into calculated accounts 268. Account objects 260 are provided with a set of financial functions to perform “what-if” calculations, such as a calculation of how much a lump sum would grow to over a number of years, or what an initial investment would need to be to provide a given sum at a specified future point in time.

Streams 280 include income streams 282 and expenditure streams 284. An income stream is an external source of money that is directed into a particular account, for example salary, pension payments, money earned from property, dividend income and cash windfalls. Some income streams are defined as “one-off” income streams because they define a single amount of money in a particular period, such as a “windfall” or “bonus”.

An expenditure stream 284 transfers money out of an account. Typical expenditure streams are “rent”, “living expenses” and “tax payments”. Some expenditure streams are defined as “one-off” expenditure streams, such as “buying a car” or “paying a house deposit”.

A financial action 290 defines an isolated financial or model parameter change. Several types of action may be defined. A transaction 292 moves wealth from one account to another. A change event action 294 changes parameters of an event defined using the lifeplan movie, for example moving an event forwards or backwards in time, or adding a new event. A create account action 296 creates a new real or calculated account. A change income stream action 298 amends details of an income stream 282, for example by reducing or increasing the rate of flow of money or changing the destination account. A change expenditure stream action 300 similarly changes details of a user expenditure stream.

A financial plan comprises a set of financial actions 290 which together contribute towards arriving at a particular financial objective. A financial plan is generated as a user selects suggestion options presented by the suggestion centre movie 124. Each financial plan has an effect on one or more of the accounts 260. At least two types of financial plans are defined, “regular investment plans” which define regular payments of the same amount over a given time frame, and “irregular investment plans” which define varying payments and actions. The actions of a financial plan therefore contain or define parameters which are used by the financial model 250.

The suggestion engine 350, implemented by the suggestion engine module 174 in conjunction with suggestion engine rules and parameters 222 which may be stored in the database 74, generates financial suggestions based on the financial model parameters and other data available. A way in which the suggestion engine 350 may be implemented by the suggestion engine module 174 using an object-oriented construction is shown in FIG. 11, which shows a hierarchy of inherited objects.

When the suggestion engine 350 is run it constructs a financial model 250 based on the available financial model parameters and then executes a series of suggestion steps 352. The suggestion steps are ordered, but some may be skipped if they are not applicable based on the available data. The steps 352 may implement the following suggestion stages: “pay off credit card debt”, “pay off general loans”, “address current income deficits”, “build up a rainy day fund”, “save for an event on the lifeplan”. The first four of these stages may be referred to as system suggestions, while the fifth depends on what events have been defined by a user.

Appropriate rules drive the various steps 352 so that, for example, a “pay off credit card debt” step is skipped if there is no such debt. For each event generated using the lifeplan movie the suggestion engine 350 attempts to create a savings, investment or debt-funded plan to successfully achieve the event. Events are processed according to the prioritisation specified by the user when executing an instance of the suggestion centre movie 124. For each event, the suggestion engine 350 also takes into account the users attitudes to risk, which are used to map onto likely investment returns.

The suggestion engine 350 approaches saving for defined events by considering intervals of time between successive events. First, the engine calculates if the funds required to achieve the event can be saved starting from the time of the previous event. If extra funds are required, the engine calculates if the funds can be saved starting from an earlier time. Finally, the engine will propose funding an event from existing savings. If the event still cannot be funded then the engine will propose alternative options, for example by delaying the event or reducing the event cost. Examples of such proposals are delaying retirement and buying a cheaper house.

Each step 352 of the suggestion engine 350 thus gives rise to a series of options 354, each of which addresses the needs of the corresponding step. If an option is selected by a user then it can give rise to one or more financial plans 356, each comprising one or more actions 290 as discussed above with reference to FIG. 10.

Referring now to FIG. 12, there is shown a graphical user interface GUI 370 presented at the client 82 by execution of the lifeplan movie 122 by the web browser 84. While putting this GUI 370 into effect, the web browser 84 is in communication with the lifeplan module 152 of the main application, by means of the network 86 and dialogue manager 100 of the user interface component 78.

The GUI 370 presents information to the user of the client 82, by means of a visual display unit, and receives input by a user controlling a cursor using a computer mouse having selection buttons, and also by use of a keyboard provided at the client 82.

In addition to the features set out below, the GUI 370 may provide any or all of the features discussed in respect of FIGS. 1 and 2 above. In particular, a timeline navigation element may be provided, to control the display scope of the event schedule graphic and associated indicator variable graphics. This display scope might typically be 10 years, of a 40 year timeline.

When the lifeplan movie 122 is executed it requests execution of the financial model module 172 by the application server 72. The calculated time series of indicator variables, such as “spare income”, “amount of short-term debt” and “net worth” are passed to the web browser 84 and are displayed as one or more indicator variable graphics 372. These may be x-y plots, LED charts, bar charts or any other type of graph. The graphics illustrated in FIG. 12 are bars of coloured blocks in which each block is coloured according to a colour key 374 shown alongside the corresponding graphic. A single coloured block represents a particular interval of time, for example one year.

Also displayed as part of the GUI 370 is a event schedule graphic 376. This graphic has a time axis corresponding to the time axes of the indicator variable graphics, and is preferably disposed in the vicinity of, parallel to and in line with the indicator graphics so as to improve the clarity to the user of the interactions and display mechanisms described below. In particular, the event schedule graphic may comprise a plurality of blocks, each block corresponding logically and in position to a block of one of the indicator variable graphics 372.

A pallette 378 of event selector widgets 380 is displayed and enables a user of the GUI 370 to request generation of a new financial event. Each of a plurality of event selector widgets 380 launches the creation of a new event of a particular type, or class of types for example using a list picker. For example, the widgets could be labelled “home”, “job”, “family”, “extras” and “retire”. The creation of a new event requires input of data relating to the event, including the more particular type of event (“buy a first home”, “pay off mortgage”), particular financial parameters (“cost of home”), and a time parameter. The particular type and financial parameters may be entered using a pop-up dialogue box or similar, while the time parameter may conveniently be entered by indicating a point in the GUI 370 on or relative to the event schedule graphic 376.

Conveniently, a drag and drop action from one of the event selector widgets 380 to the event schedule graphic 376 may be used to set the time parameter, by location of the drop action. A dialogue box 384 for entering the remaining parameters may be launched before or following the drop action.

An event marker 382 is preferably presented by the GUI on or adjacent to the event schedule graphic 376 to represent each generated event. The marker preferably indicates graphically the type or class of event which it represents, for example by means of text or an icon. In the embodiment of FIG. 12 the event markers 382 take the form of flags. Each event marker can be selected and moved using a drag and drop action to another part of the event schedule graphic 376 to change the corresponding event time parameter. Each event marker 382 can also be selected to re-launch an appropriate dialogue box 384 to change other event parameters, and/or to see a suggestions summary, if the suggestions centre movie has already been run. Facilities may also be provided to delete an event, for example by dragging an event marker and dropping it on a disposal graphic or widget, such as a trash can (rubbish bin) icon.

When a new event is generated or an existing event is modified the financial model 250 is re-executed and the resulting time series of indicator variables are used to redraw the indicator variable graphics 372.

The event selector widgets may be implemented as buttons, drop down menus or in any other suitable form. The event schedule graphic could be incorporated in or form part of one or more of the indicator variable graphics.

An interface element 386 is provided to enable a user to proceed to obtaining financial suggestions on the basis of the financial parameters input using the user profile entry movie 120 and the lifeplan movie 122. As discussed above, these suggestions are provided using an interactive suggestion centre movie 124. An early stage of providing these suggestions may be to request the user to prioritize the events set up using the lifeplan movie 122. This prioritization can be achieved using a prioritization interface 390 as illustrated in FIG. 13. The events are listed in a tabular form. Arrow buttons 392 within the table can be used to promote or demote each event and radio buttons 394 can be used to select a risk or caution factor which the user would like to associate with any financial plans generated for saving for the event.

Financial suggestions are presented to the user in the stages discussed above with reference to FIG. 11. The user selects particular suggestion options and the suggestion engine 350 generates one or more financial plans, which may be recorded in the suggestion session data 206 of a customer profile 200 of the database 74. The user then may return to the lifeplan movie 122. FIG. 14 illustrates a graphical user interface presented by an instance of the lifeplan movie 122 executing on a client 82 after one or more financial plans have been generated. In addition to the features shown in FIG. 12, and optionally any additional features which may be incorporated from FIGS. 1, 2, and the discussion thereof, a financial plan graphic 400 may also be displayed. This graphic has a time axis parallel to and vertically in line with the time axes of the event schedule graphic 376 and the indicator variable graphics 372, and indicates the time extent of each financial plan by means of a bar extending parallel to the time axis. Preferably, the bar or other feature representing each plan can be selected using a pointing device to launch a dialogue box relating to the particular plan, or other interface means allowing viewing or editing of parameters of the selected plan. Alternatively, the financial plan graphics could be omitted and details of plans made available by selecting a part or all of a relevant event flag.

The lifeplan movie 122 may allow editing of financial plan parameters and events following generation of financial plans, requesting recalculation of the indicator variables and redisplaying the indicator variable graphics as necessary. Alternatively, or for some particular changes, it may be necessary to re-execute the suggestion centre movie 124 to generate fresh financial plans. Changes to financial plans relating to a particular suggestion stage may require the user to be taken through the subsequent suggestion stages again.

Features of the embodiments described with reference to FIGS. 3 to 15 may be used in other embodiments, for example outside the field of financial planning.

1. A computer apparatus comprising:
a model component adapted to calculate time series of one or more indicator variables dependent on a plurality of model parameters, at least some of said model parameters being event parameters relating to one or more events, each event having at least one associated event time parameter; and
a user interface component adapted to cause at least a part of the scope of said time series to be graphically represented as an event schedule graphic and to enable a user to position one or more event markers relative to said event schedule graphic, said user interface component being further adapted to cause one or more of said event time parameters to be set dependent on the position of each event marker relative to the event schedule graphic.

2. The apparatus of claim 1 wherein the event schedule graphic provides only a single control dimension of event time.

3. The apparatus of claim 1 wherein the user interface further comprises a timeline navigation element, and the event schedule graphic represents a controllable part of the scope of said time series, the part of the scope being controllable using the timeline navigation element.

4. The apparatus of claim 3 wherein the timeline navigation element displays a concurrent representation of substantially the whole of said time series.

5. The apparatus of claim 1 wherein the user interface is adapted to enable a user to exclude one or more existing events, whereby the associated event parameters are excluded from the model component calculation.

6. The apparatus of claim 5 whereby the exclusion of an event is represented in the user interface by colouration or discolouration of the associated event marker.

7. The apparatus of claim 1 wherein the user interface component is further adapted to cause said time series of said one or more indicator variables to be graphically displayed as indicator variable graphics at the same time as display of said event schedule graphic.

8. The apparatus of claim 7 wherein said event schedule graphic and said indicator variable graphics each have a time axis, and said time axes are substantially parallel and of substantially the same scope.

9. The apparatus of claim 1 wherein the user interface component is further adapted to cause the model component to recalculate said indicator variables following setting of one or more of said event parameters.

10. The apparatus of claim 1 wherein the user interface component is further adapted to:
cause one or more event selectors to be graphically displayed at the same time as said event schedule graphic, each event selector being associated with a different type or class of event;
enable a user to select one of said event selectors and to select a corresponding drop position relative to said event schedule graphic;
cause an event of the selected event type or class to be generated; and
to cause an event time parameter for the generated event to be set, the value of the event time parameter being set dependent on the drop position relative to said event schedule graphic.

11. The apparatus of claim 1 wherein selection of an event marker positioned relative to said schedule graphic and associated with an event launches a user interface event dialogue element adapted to receive from a user changes to the event parameters associated with said event.

12. The apparatus of claim 1 wherein the event schedule graphic is divided into a plurality of event schedule time regions, each region representing a time interval of said time series.

13. The apparatus of claim 1 wherein the user interface component is adapted to enable a user to move said event markers relative to said event schedule graphic, and to cause an event time parameter of an event associated with an event marker to be updated dependent on the new position of the event marker relative to the event schedule graphic.

14. The apparatus of claim 1 wherein the apparatus is a financial planning apparatus, the model component implements a financial model and the events are financial events.

15. The apparatus of claim 14 wherein the indicator variables are selected from a list including spare income, amount of debt, and net worth.

16. The apparatus of claim 14 further comprising a suggestion engine adapted to generate financial suggestions dependent on the plurality of model parameters including the event parameters, and to enable a user to build one or more financial plans based on said suggestions.

17. The apparatus of claim 16 wherein model parameters relating to events currently excluded in the user interface are neglected in the generation of financial suggestions.

18. The apparatus of claim 16 wherein said user interface component is further adapted to cause a suggestion selector to be displayed, selection of said suggestion selector causing execution of said suggestion engine.

19. The apparatus of claim 16 wherein the user interface component is adapted to cause said financial plans, when built, to be represented as one or more plan graphics displayed at the same time as said event schedule graphic, and to cause said indicator variable graphics to display time series of said indicator variables calculated taking said financial plans into account.

20. The apparatus of claim 19 wherein selection of one of said plan graphics by a user launches a user interface plan dialogue element adapted to accept from a user changes to parameters associated with the corresponding financial plan.

21. A graphical user interface comprising:
one or more indicator variable graphics displaying time series of one or more indicator variables calculated using a model on the basis of a plurality of model parameters, at least some of said model parameters being event parameters relating to one or more events, each event having at least one associated event time parameter;
an event schedule graphic representing at least a part of said time series; and
an event marker facility adapted to enable a user to place one or more event markers in locations relative to said schedule graphic, and to cause to be generated event parameters for an event corresponding to each event marker, an event time parameter for each event so generated being set according to the location of the marker relative to the event schedule graphic.

22. The graphical user interface of claim 21 wherein the event schedule graphic provides only a single control dimension of event time.

23. The graphical user interface of claim 21 further comprising a timeline navigation element, the event schedule graphic representing a controllable portion of said time series, the portion of said time series being controllable using the timeline navigation element.

24. The graphical user interface of claim 23 wherein the timeline navigation element displays a concurrent representation of substantially the whole of said time series.

25. The graphical user interface of claim 21 wherein the user interface is adapted to enable a user to exclude one or more existing events, whereby the associated event parameters are excluded from the model calculation.

26. The graphical user interface of claim 25 whereby the exclusion of an event is represented in the user interface by colouration or discolouration of the associated event marker.

27. The graphical user interface of claim 21 wherein each event time parameter defines a position in said time series.

28. The graphical user interface of claim 21 wherein the event schedule graphic and each indicator variable graphic has a time axis, and the time axes are substantially parallel and of substantially the same scope.

29. The graphical user interface of claim 21 further comprising an event edit facility adapted to enable a user to update event parameters associated with an event represented as an event marker.

30. The graphical user interface of claim 29 wherein the event edit facility is accessed by selecting an event marker using a pointing device controlling a graphical cursor.

31. The graphical user interface of claim 21 wherein each event marker is moveable relative to said event schedule graphic using a pointing device controlling a cursor, the interface being adapted to cause the event time parameter to be updated in accordance with movement of the event marker.

32. The graphical user interface of claim 21 arranged such that the indicator variable graphics automatically display recalculated time series of said one or more indicator variables in response to changes to said model parameters.

33. The graphical user interface of claim 21 wherein the user interface is a financial planning user interface, the indicator variables are financial variables and the events are financial events.

34. The graphical user interface of claim 33 further comprising a suggestions selector, selection of said suggestions selector by a user causing execution of a suggestion engine arranged to generate one or more financial suggestions.

35. The graphical user interface of claim 34 wherein model parameters relating to events currently excluded in the user interface are neglected in the generation of financial suggestions.

36. The graphical user interface of claim 34 further comprising one or more financial plan graphics illustrating the extent of each financial plan within said time series.

37. A financial planning tool comprising:
a user profile entry module adapted to receive a plurality of financial parameters from a user;
a lifeplan module adapted to receive a plurality of event parameters relating to a plurality of financial events from a user, said event parameters including at least one event time parameter for each event; and
a financial model module adapted to calculate time series of one or more indicator variables from said financial parameters and said event parameters.

38. The financial planning tool of claim 37 further comprising a lifeplan user interface adapted to enable a user to generate one or more events and to place said events at selected points within said time series, said lifeplan user interface further displaying graphically said time series of said indicator variables.

39. The financial planning tool of claim 37 further comprising a suggestion centre module arranged to provide a user with financial suggestion options calculated from said financial parameters and said event parameters, and to enable said user to select preferred ones of said financial suggestion options so as to build one or more financial plans, each financial plan comprising a plurality of plan parameters.

40. The financial planning tool of claim 39 further comprising a suggestion engine module adapted to calculate said financial suggestion options and to pass said financial suggestion options to said suggestion centre module.

41. A method of automatically calculating a plurality of financial suggestion options from a plurality of financial parameters describing the financial position of a user and a plurality of event parameters describing financial goals of said user, comprising:
following a predefined sequence of suggestion steps, each step relating to a predefined suggestion area; for each suggestion step determining from said financial parameters and said event parameters whether or not to calculate suggestion options for that step;
for each suggestion step for which suggestion options are to be calculated, calculate suggestion options for that step.

42. The method of claim 41 further comprising: for each step for which suggestion options are calculated, receiving a selection of said suggestion options from said user, and building a financial plan for each such step based on the selected suggestion options, each financial plan including one or more plan parameters.

43. The method of claim 42 wherein the suggestion options calculated for a following step are calculated using the plan parameters of a financial plan built in a previous step.

44. The method of claim 41 wherein said steps comprise two or more suggestion steps taken from the following sequence: paying off credit card debt, paying off general loans, addressing current income deficits, building a rainy day fund, saving for one or more events defined by said event parameters, getting life insurance, overpaying mortgage and thinking about inheritance tax.

45. The method of claim 44 wherein said steps further comprise a suggestion step of saving for retirement.

46. A computer implemented planning tool for assisting a user in planning for one or more future events, the planning tool including a computer model for calculating future values of one or more variables based on a plurality of model parameters, at least some of said model parameters defining future events to be included in the model, the planning tool providing:
a timeline area displaying a timeline enabling a user to define one or more events with reference to the timeline; and
an options area displaying one or more options calculated by the planning tool to enable the user to plan for the one or more defined events.

47. The planning tool of claim 46 wherein the timeline area also enables a user to change the parameters defining an event, including moving the time of the event.

48. The planning tool of claim 46 wherein the timeline area also enables a user to suspend a defined event, a suspended event being excluded from the calculations of the computer model until the suspension is ended.

49. The planning tool of claim 46 wherein the options area enables a user to prioritize defined events, and wherein the planning tool accounts for the prioritization when calculating said options.

50. The planning tool of claim 46 wherein the options area further enables the user to select a subset of the calculated options.

51. The planning tool of claim 50 further comprising a to-do list area displaying actions which a user should take to put one or more of the selected subset of options into effect.

52. The planning tool of claim 46 wherein the planning tool is a financial planning tool, the events are finance-related events, and the options relate to possible courses of action of a user in planning financially for the events.

53. A computer implemented planning tool having distributed functional elements for the calculation of personal finance strategies comprising an application component, a user interface component and a database component.

54. The computer implemented planning tool of claim 53 wherein the application component comprises a financial model element adapted to calculate future values of one or more financial variables based on model parameters, said model parameters including parameters defining one or more future financial events.

55. The computer implemented planning tool of claim 54 wherein the application component comprises a timeline element adapted to arrange the display to a user of a timeline interface which enables the user to define one or more of said financial events.

56. The computer implemented planning tool of claim 53 wherein said application component further comprises an options element adapted to calculate one or more options, each option representing a financial scheme to assist the user in achieving one of said events.

57. The computer implemented planning tool of claim 53 wherein the elements of the application component communicate with users using one or more user interface elements included in the user interface component.

58. The computer implemented planning tool of claim 57 wherein the user interface component includes a network interface connectable to a network for communication with one or more users thereby.

59. A computer program product containing computer program code elements which when executed on a computer, perform a method of automatically calculating a plurality of financial suggestion options from a plurality of financial parameters describing the financial position of a user and a plurality of event parameters describing financial goals of said user, the method comprising:
following a predefined sequence of suggestion steps, each step relating to a predefined suggestion area; for each suggestion step determining from said financial parameters and said event parameters whether or not to calculate suggestion options for that step;
for each suggestion step for which suggestion options are to be calculated calculate suggestion options for that step.

60. A computer program product containing computer program code elements which, when loaded on a computer system, provide a computer apparatus comprising:
a model component adapted to calculate time series of one or more indicator variables dependent on a plurality of model parameters at least some of said model parameters being event parameters relating to one or more events, each event having at least one associated event time parameter; and
a user interface component adapted to cause at least a part of the scope of said time series to be graphically represented as an event schedule graphic and to enable a user to position one or more event markers relative to said event schedule graphic, said user interface component being further adapted to cause one or more of said event time parameters to be set dependent on the position of each event marker relative to the event schedule graphic.

61. A computer program product containing computer program code elements which, when executed on a computer system having suitable visual display and input means, provide a graphical user interface comprising:
one or more indicator variable graphics displaying time series of one or more indicator variables calculated using a model on the basis of a plurality of model parameters, at least some of said model parameters being event parameters relating to one or more events, each event having at least one associated event time parameter;
an event schedule graphic representing at least a part of said time series; and
an event marker facility adapted to enable a user to place one or more event markers in locations relative to said schedule graphic, and to cause to be generated event parameters for an event corresponding to each event marker, an event time parameter for each event so generated being set according to the location of the marker relative to the event schedule graphic.

62. An apparatus providing a graphical user interface comprising:
one or more indicator variable graphics displaying time series of one or more indicator variables calculated using a model on the basis of a plurality of model parameters, at least some of said model parameters being event parameters relating to one or more events, each event having at least one associated event time parameter;
an event schedule graphic representing at least a part of said time series; and
an event marker facility adapted to enable a user to place one or more event markers in locations relative to said schedule graphic, and to cause to be generated event parameters for an event corresponding to each event marker, an event time parameter for each event so generated being set according to the location of the marker relative to the event schedule graphic.

63. A computer program product containing computer program code elements which, when executed on a suitable computer system provides
a computer implemented planning tool for assisting a user in planning for one or more future events, the planning tool including a computer model for calculating future values of one or more variables based on a plurality of model parameters, at least some of said model parameters defining future events to be included in the model, the planning tool comprising:
a timeline area displaying a timeline enabling a user to define one or more events with reference to the timeline; and
an options area displaying one or more options calculated by the planning tool to enable the user to plan for the one or more defined events.
